(19) United States
(12) Patent Application Publication
(10) Pub. No.: US 2006/0149429 A1
(43) Pub. Date: Jul. 6, 2006

(54) Acceleration display device mounted in vehicle

(75) Inventor: Shinichirou Aizawa, Tsukui-gun (JP)

Correspondence Address: ERIC ROBINSON, PMB 955, 21010 SOUTHBANK ST., POTOMAC FALLS, VA, 20165, US

(73) Assignee: Kabushiki Kaisha Kenwood, Hachiouji-shi (JP)

(21) Appl. No.: 11/322,259

(22) Filed: Jan. 3, 2006

(30) Foreign Application Priority Data
Jan. 4, 2005 (JP) 2005-000114
Jan. 5, 2005 (JP) 2005-000731

(51) Int. Cl. G06F 17/00

(52) U.S. Cl. 701/1; 701/76

(57) ABSTRACT

In-vehicle display apparatus includes a unit for detecting an acceleration of a vehicle and outputting an acceleration detection signal, a display control unit for outputting a display control signal to perform a graphic display of the acceleration of the vehicle in a mode according to the change therein, and a display unit for graphic display. The acceleration information is detected by the acceleration detecting unit as points, and the points are added up at predetermined time intervals. The added-up data as stored in a memory unit so as to display it graphically on the display unit. The in-vehicle device stores multiple pieces of the data added up in the past in the memory unit, and graphically displays them in series on the display unit.

### BACKGROUND OF THE INVENTION

1. Field of the Invention

The present invention relates to an in-vehicle display device and a program thereof.

2. Related Background Art

Conventionally, there are inventions of devices for detecting an acceleration of a vehicle with an acceleration sensor and exerting various kinds of control by using a detection signal thereof.

To be more precise, there is a known rollover prevention device (JP Laid-Open 2003-320914A) which detects a rolling angle and an acceleration in lateral of the vehicle and determines a load condition of the vehicle based on the detection signal to urge a driver to avoid a danger by using a roll indicator and an unbalanced load indication lamp.

In recent years, various in-vehicle devices to be mounted in the vehicle are developed, such as a car navigation device and a car audio device. These devices have display panels provided thereon, which can display various kinds of information, such as geographical information and guidance information showing a traveling direction of the vehicle, audio volume and tunes.

The acceleration detected by the acceleration sensor corresponds to the acceleration felt longitudinally and crosswise by the driver according to driving performance of the driver, such as accelerating by stepping on an accelerator, decelerating by stepping on a brake and curving by turning a steering wheel to the right or left. Therefore, if the acceleration felt by the driver can be displayed on the display panel of the in-vehicle device, the driver can visually enjoy the acceleration variable by the driver's own driving performance.

As for the display method of the rollover prevention device of JP Laid-Open 2003-320914, it is not easy to visually grasp a degree of change in the acceleration exerted on the vehicle because of use of the roll indicator and unbalanced load indication lamp. In addition, the acceleration is exerted on the vehicle not only crosswise but also longitudinally against the traveling direction of the vehicle, and so there is a limit to displaying the longitudinal acceleration by the display method of Patent Document 1. It is possible to remind the driver by displaying a roll status of the vehicle while driving it. However, it is not sufficient for the purpose of showing driving characteristics of the driver.

### SUMMARY OF THE INVENTION

A first aspect of the present invention provides an in-vehicle display device capable of visually informing a driver of a mode of a change in an acceleration exerted on a vehicle.

A second aspect of the present invention provides the in-vehicle display device capable of adding up and displaying acceleration points according to the acceleration exerted on the in-vehicle device per unit time and visually informing the driver of driving characteristics.

The in-vehicle display device according to the first aspect of the present invention is the one comprising:

acceleration detecting means for detecting an acceleration of a mounting vehicle and outputting an acceleration detection signal;

display control means for outputting a display control signal for performing a graphic display of the acceleration of the vehicle based on the acceleration detection signal in a mode according to a change therein; and

display means for performing the graphic display based on the display control signal.

The device is the one wherein:

the display control means outputs the display control signal for displaying a level display mode according to the change in the acceleration of the vehicle on a display screen based on the acceleration detection signal each time the acceleration changes.

The device is the one wherein:

the display control means comprises:

determination means for determining whether or not the acceleration of the vehicle has reached a maximum based on the acceleration detection signal; and

suspension control means for exerting control to suspend an update of the graphic display of the display means in the case where the determination means determines that the acceleration of the vehicle has reached the maximum.

The device is the one wherein:

the display control means comprises:

determination means for determining whether or not the acceleration of the vehicle has reached the maximum based on the acceleration detection signal; and

update speed slowing control means for exerting control to slow an update speed of the graphic display of the display means for a fixed period in the case where the determination means determines that the acceleration of the vehicle has reached the maximum.

The device is the one wherein:

the acceleration detecting means detects the acceleration crosswise and/or longitudinal against a traveling direction of the vehicle.

The device is the one wherein:

the level display mode is a vehicle image having an inclination of the vehicle toward the traveling direction changed according to the acceleration of the vehicle.

The device is the one wherein:

the level display mode is a vehicle image having a display size of the vehicle changed according to the acceleration of the vehicle.

The device is the one wherein:

the level display mode is a meter-like image representing the acceleration of the vehicle.

The device is the one wherein:

the level display mode is a numerical image representing the acceleration of the vehicle.

The device is the one further comprising:

comment attaching means for storing the acceleration of the vehicle by associating detection time information therewith in the case where the determination means determines that the acceleration of the vehicle has reached the maximum.

The device is the one further comprising:

transfer means for transferring the acceleration of the vehicle to an external device capable of processing data.

The device is the one further comprising:

obtaining means for obtaining position information on the vehicle; and wherein, the display control means outputs the display control signal for performing the graphic display based on the position information obtained by the obtaining means.

The device is the one further comprising:

the obtaining means for obtaining the position information on the vehicle; and

position information storing means for storing the acceleration of the vehicle by associating it with the position information obtained by the obtaining means.

The device is the one further comprising:

audio output means for audio-outputting the acceleration of the vehicle in predetermined timing.

A program according to the first aspect of the present invention, wherein:

the program causes a computer to function as:

acceleration detecting means for detecting an acceleration of a mounting vehicle and outputting an acceleration detection signal;

display control means for outputting a display control signal for performing a graphic display of the acceleration of the vehicle based on the acceleration detection signal in a mode according to a change therein; and

display means for performing the graphic display based on the display control signal.

The in-vehicle display device according to the second aspect of the present invention is the one comprising:

timing means for timing a predetermined unit time;

acceleration calculating means for detecting an acceleration exerted on the in-vehicle device and calculating acceleration points according to the acceleration;

storing means for adding up and storing the acceleration points per unit time; and

display means for displaying the stored acceleration points.

The device is the one wherein:

the storing means stores a plurality of the acceleration points currently added up and acceleration points added up in the past in historical order; and

the display means performs the graphic display of the plurality of stored acceleration points in historical order.

The device is the one wherein:

the display means changes a scale of a graph to be displayed according to the largest acceleration points out of the plurality of acceleration points of which graphic display is performed.

The device is the one further comprising:

average calculating means for calculating an average based on the plurality of stored acceleration points; and wherein,

the display means displays the calculated average.

The device is the one wherein:

the display means displays the acceleration points equal to or larger than the average in a different color based on the calculated average.

The device is the one further comprising:

warning means for beeping in the case where the acceleration points exceed the calculated average.

The device is the one further comprising unit time setting means for setting the unit time.

The device is the one further comprising:

changing means for changing a conversion setting on acceleration point calculation according to the acceleration by the acceleration calculating means.

The device is the one further comprising:

receiving means for receiving user identifying information for identifying a user, and wherein:

the storing means adds up and stores the acceleration points for each individual user according to the user identifying information; and

the display means displays the acceleration points for each individual user.

The device is the one further comprising:

current position detecting means for detecting a current position of the in-vehicle device; and

geographical information storing means for storing geographical information, and wherein:

the storing means stores the acceleration points at the current position; and

the display means displays the acceleration detected at each individual position on a map based on the acceleration points and geographical information at the stored position.

### BRIEF DESCRIPTION OF THE DRAWINGS

FIG. 1 shows an example of a perspective view of an in-vehicle audio system;

FIG. 2 shows an example of a top view of a motherboard;

FIG. 3 is a block diagram showing a configuration example of major functions of the in-vehicle audio system;

FIG. 4 is a block diagram showing an example of a functional configuration of an I/O control unit;

FIG. 5A is a diagram showing an example of a data configuration of a memory unit, and FIG. 5B is a diagram showing an example of a data configuration of an RAM;

FIG. 6 is a diagram showing an example of a table configuration of a G graphic pattern table;

FIG. 7 is a first flowchart for describing G graphic control processing;

FIG. 8 is a second flowchart for describing the G graphic control processing;

FIG. 9 is a diagram showing an example of screen transition of a display panel of the in-vehicle audio system;

FIG. 10 is a diagram showing an example of a table configuration of the G graphic pattern table in a deformed example;

FIGS. 11A and 11B are diagrams showing display examples of G graphics in deformed examples;

FIG. 12 is a diagram schematically showing a functional configuration of an in-vehicle display device according to the present invention;

FIG. 13 is a flowchart for describing operation of the in-vehicle device according to an embodiment of the present invention;

FIG. 14A is a flowchart for describing point addition processing, FIG. 14B is a flowchart for describing G point data shift processing, and FIG. 14C is a flowchart for describing scale update processing;

FIG. 15A is a diagram showing a main display unit of a display unit, FIG. 15B is a diagram showing a display example in the case where the largest points are around 500, and FIG. 15C is a diagram showing a display example in the case where the largest points are around 1,000;

FIG. 16 are diagrams showing display examples of graphs of the main display unit, where FIG. 16A is a diagram showing a configuration of a graph and FIGS. 16B to 16G are diagrams showing that G points are sequentially added as time elapses;

FIG. 17 is a diagram showing a display example of the main display unit for displaying crosswise acceleration information; and

FIG. 18 is a diagram showing a display of a GPS information display unit of a deformed example of an in-vehicle device 1.

### DESCRIPTION OF THE PREFERRED EMBODIMENTS

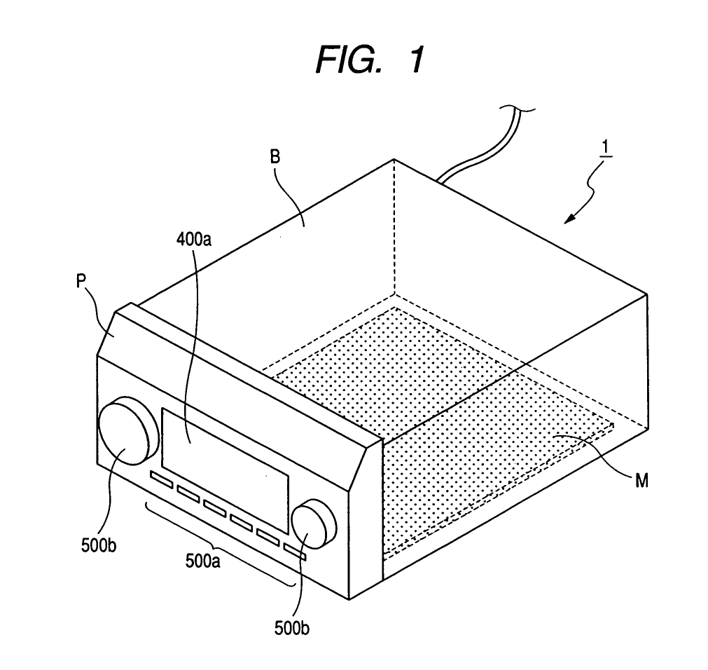

A description will be given by referring to FIGS. 1 to 11 as to an embodiment in the case of applying an in-vehicle acceleration display device according to a first aspect of the present invention to an in-vehicle audio system. The present invention is not only applicable to the in-vehicle audio system but also applicable to an in-vehicle device such as a vehicle navigation system as appropriate.

FIG. 1 is a perspective view of an in-vehicle audio system 1. The in-vehicle audio system 1 is configured by including a main body B and a panel P. The panel P comprises a display panel 400a for displaying various display screens and an input unit 500 having a switch 500a, a dial 500b and the like, and functions as a user interface of the in-vehicle audio system 1, so to speak.

The in-vehicle audio system 1 is mounted in proximity to a driver's seat so that the panel P faces the driver's seat. Therefore, a backside of the in-vehicle audio system 1 faces a front of a vehicle while the panel P side faces the backside of the vehicle. A user selects a screen to be displayed on the display panel 400a by operating the switch 500a and dial 500b of the panel P. In particular, the in-vehicle audio system 1 of this embodiment has a reproduction mode for displaying a tune and a channel number on reproducing music and a radio voice and a graphic mode for displaying a G graphic which will be described later. The user operates the input unit 500 to select one of the reproduction mode and graphic mode.

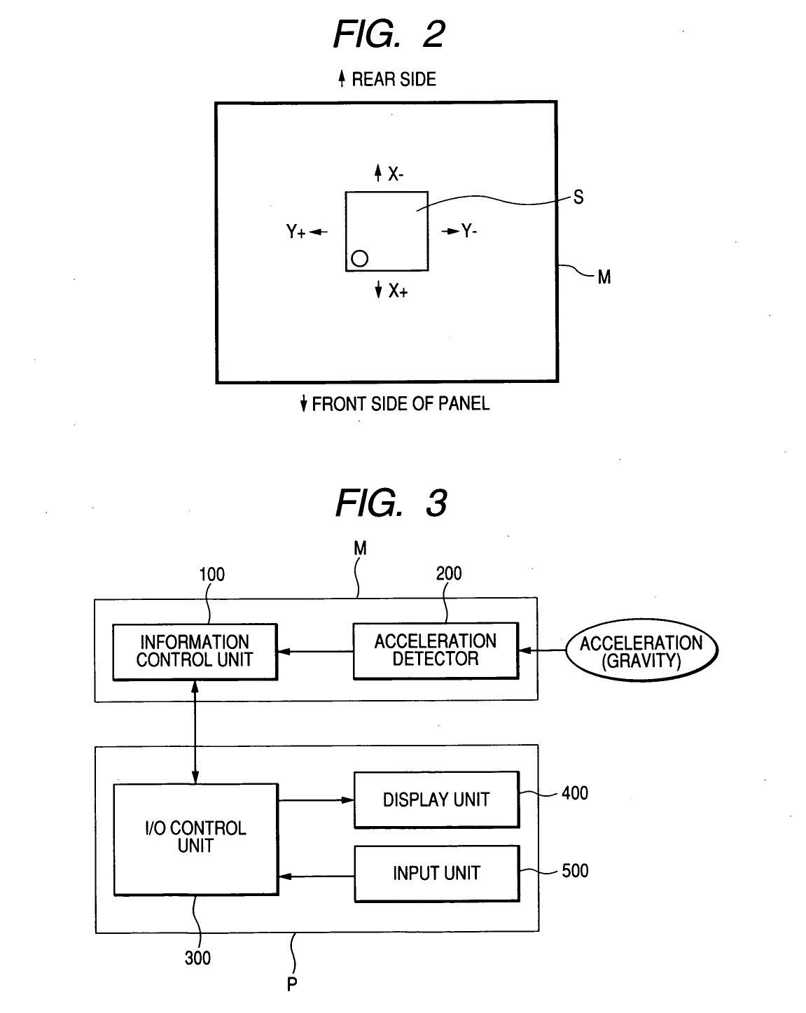

The main body B houses various circuit boards, interfaces with external devices, a power supply and so on. According to FIG. 1, the main body B houses a motherboard M inside. FIG. 2 shows an overview of a top view of the motherboard M. The motherboard M an acceleration sensor S placed thereon.

The acceleration sensor S is the acceleration sensor of a strain gage method, an electrodynamic method or a capacitance type for instance, and detects accelerations related to a longitudinal direction (X direction) and a crosswise direction (Y direction) of the motherboard M. And it generates analog voltage signals (acceleration detection signals) according to the detected accelerations in the X direction and Y direction as Xout and Yout.

A description will be given as to the acceleration direction detected by the acceleration sensor S by referring to the direction from the acceleration sensor S to the backside of the in-vehicle audio system 1 as an X− direction, the direction from the acceleration sensor S to the panel P side as an X+ direction, the right direction of the acceleration sensor S in FIG. 2 as a Y− direction and the left direction thereof as a Y+ direction.

FIG. 3 is a block diagram showing a configuration example of major functions of the in-vehicle audio system 1. According to FIG. 3, the motherboard M of the in-vehicle audio system 1 is configured by including an information control unit 100 and an acceleration detector 200.

The acceleration detector 200 is acceleration detecting means for outputting the voltage signals Xout and Yout generated by the acceleration sensor S to the information control unit 100. The information control unit 100 is configured by a system microcomputer or the like, and A/D-converts the analog voltages Xout and Yout outputted from the acceleration detector 200 and acquires the direction and size of the acceleration so as to output them to an I/O control unit 300.

To be more specific, the acceleration detector 200 first decides the Xout and Yout in an initial state of having no acceleration exerted as a reference voltage (1.65 V for instance). And it decides the direction and size (G) of the acceleration from relative values between the Xout and Yout outputted by the acceleration sensor S and the reference voltage.

For instance, if the Xout is 2.45 V which is larger than the reference voltage 1.65 V by 0.8 V, it decides that the acceleration of 1.0 G is exerted in the X− direction. If the Xout is 0.85 V which is smaller than the reference voltage by 0.8 V, it decides that the acceleration of 1.0 G is exerted in the X+ direction. Similarly, the acceleration detector 200 acquires the direction and size of the crosswise acceleration from the Yout and the reference voltage.

The panel P is configured by including the I/O control unit 300, a display unit 400 and the input unit 500. The I/O control unit 300 is display control means for having a mode of a change in the acceleration outputted from the information control unit 100 graphically displayed on the display unit 400 by updating a level display mode. It also switches the mode of the display screen displayed on the display unit 400 based on a manipulate signal inputted from the input unit 500.

The display unit 400 as display means is configured by including the display panel 400a configured by an FL driver, an LCD (Liquid Crystal Display) and the like, and has a graphic screen based on graphic image data outputted from the I/O control unit 300 displayed on the display panel 400a. The input unit 500 is configured by including the switch 500a and dial 500b, and outputs the manipulate signal according to the user's operation to the I/O control unit 300.

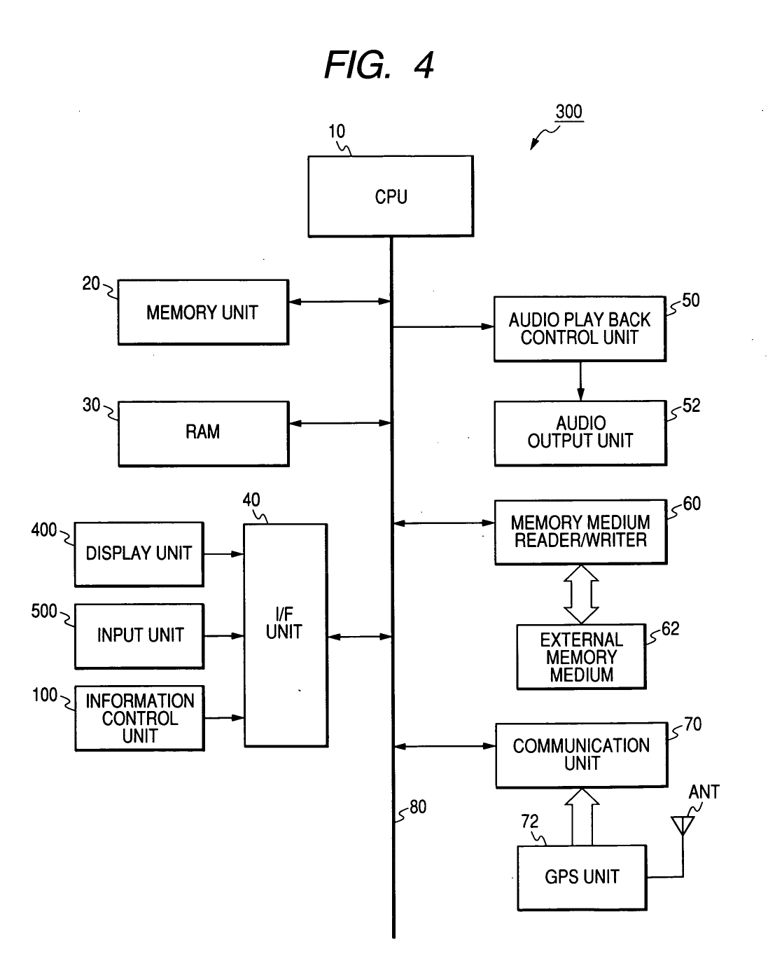

FIG. 4 is a block diagram showing an example of a functional configuration of the I/O control unit 300. According to FIG. 4, the information control unit 100 is configured by connecting a bus 80 to a CPU (Central Processing Unit) 10, a memory unit 20, an RAM (Random Access Memory) 30, an I/F unit 40 for performing data input and output with the information control unit 100, display unit 400 and input unit 500, an audio play back control unit 50 for causing an audio output unit 52 to output audio, a memory medium reader/writer 60 for reading and writing data from and to an external memory medium 62, and a communication unit 70 for communicating with an external device such as a GPS (Global Positioning System) unit 72.

The CPU 10 performs processing based on a predetermined program according to an inputted instruction and provides an instruction and performs data input and output to each individual operation unit, and is configured by a panel microcomputer for instance. To be more precise, the CPU 10 reads the program stored in the memory unit 20 according to the manipulate signal inputted from the input unit 500 via the I/O control unit 300 so as to performs the processing according to the program. And the CPU 10 outputs display data (a display control signal) for displaying a processing result to the display unit 400 so as to have the display screen according to the display data displayed on the display unit 400.

The memory unit 20 is storing means comprising a storage medium for reading and writing the data optically and magnetically, and is configured by an HDD (Hard Disk Drive) for instance. The memory unit 20 stores various programs to be executed by the CPU 10 and various kinds of data. The RAM 30 is a storage area for temporarily holding the data related to execution of various programs and the like stored in the memory unit 20 of the CPU 10.

The I/F unit 40 is the operation unit for performing the data input and output with the information control unit 100, display unit 400 and input unit 500, and is configured by a serial interface for instance.

The audio play back control unit 50 controls a CD mechanism unit, an MD mechanism unit, a DVD mechanism unit and a tuner mechanism unit (not shown) for instance to D/A convert each individual sound source and thereby generate a sound signal so as to output it to the audio output unit 52. An audio output unit 4 is configured by a speaker and the like, and outputs audio based on the sound signal outputted from the audio play back control unit 50.

The memory medium reader/writer 60 reads and writes the data from and to the external memory medium 62, such as a memory card or an FD (Floppy (registered trademark) Disk).

The communication unit 70 is the operation unit for performing data communication with the external device of the in-vehicle audio system 1 by connecting to a predetermined communication line, and is configured by including a modem, an LAN interface, a USB and the like. According to this embodiment, the data communication is performed by connecting to the GPS unit 72 as the external device.

The GPS unit 72 receives GPS signals transmitted from multiple GPS satellites via a GPS antenna ANT, and measures a current position from a time error of each of the received GPS signals. And it outputs position information on the measured current position (latitude and longitude) to the CPU 10. A public-domain technique may be used as to a method of measuring the current position as appropriate.

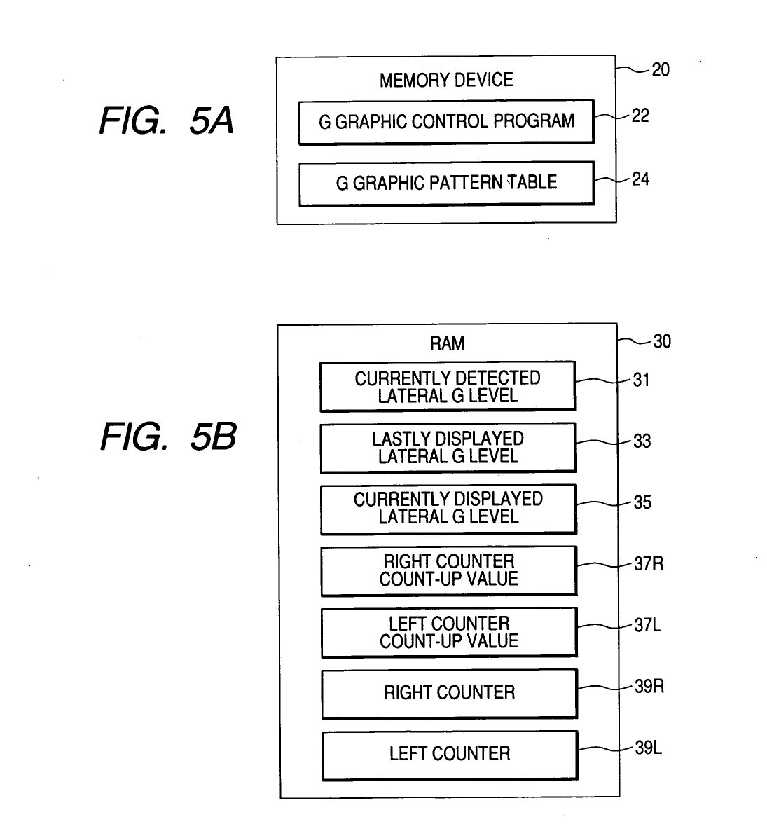

FIG. 5A is a diagram showing an example of the data configuration of the memory unit 20. According to FIG. 5A, the memory unit 20 has a G graphic control program 22 and a G graphic pattern table 24 stored therein.

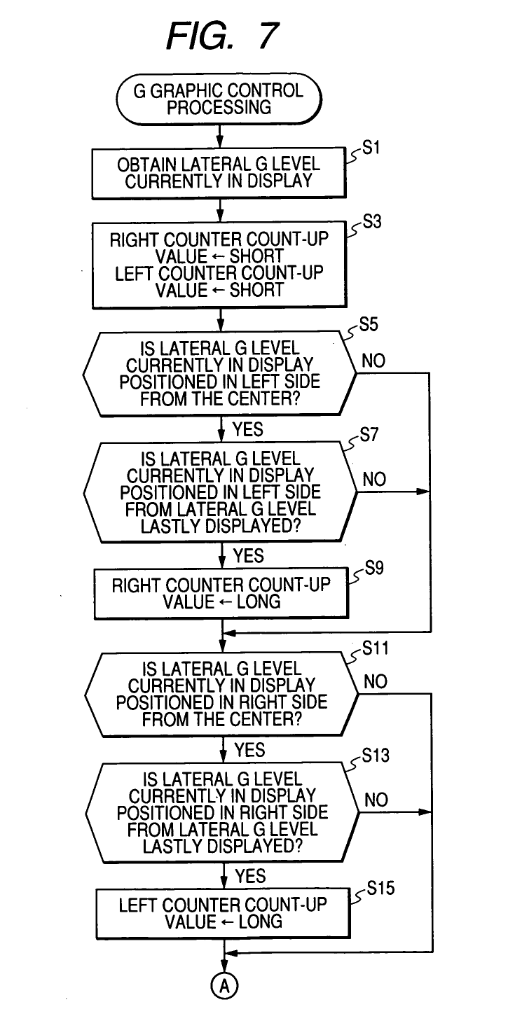

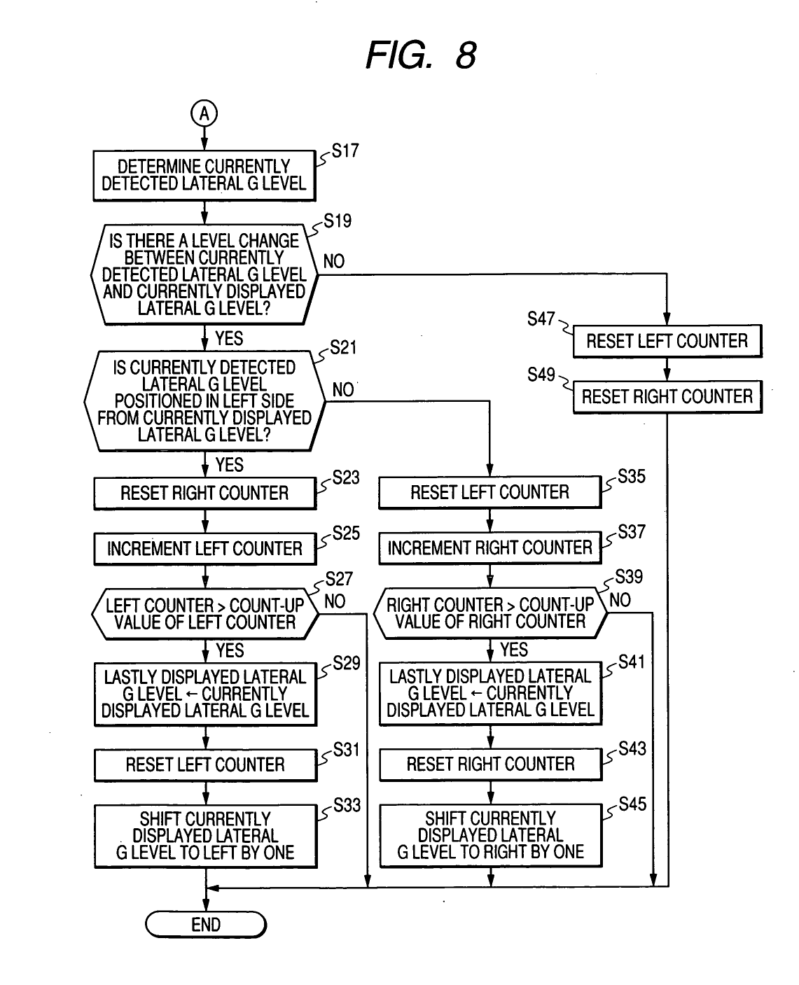

The G graphic control program 22 is a program for implementing a display control function by means of G graphic control processing (refer to FIGS. 7 and 8) according to this embodiment. On detecting that the display mode is switched to a G mode by the user operating the input unit 500, the CPU 10 reads the G graphic control program 22 stored in the memory unit 20 and expands it in the RAM 30 so as to start the G graphic control processing.

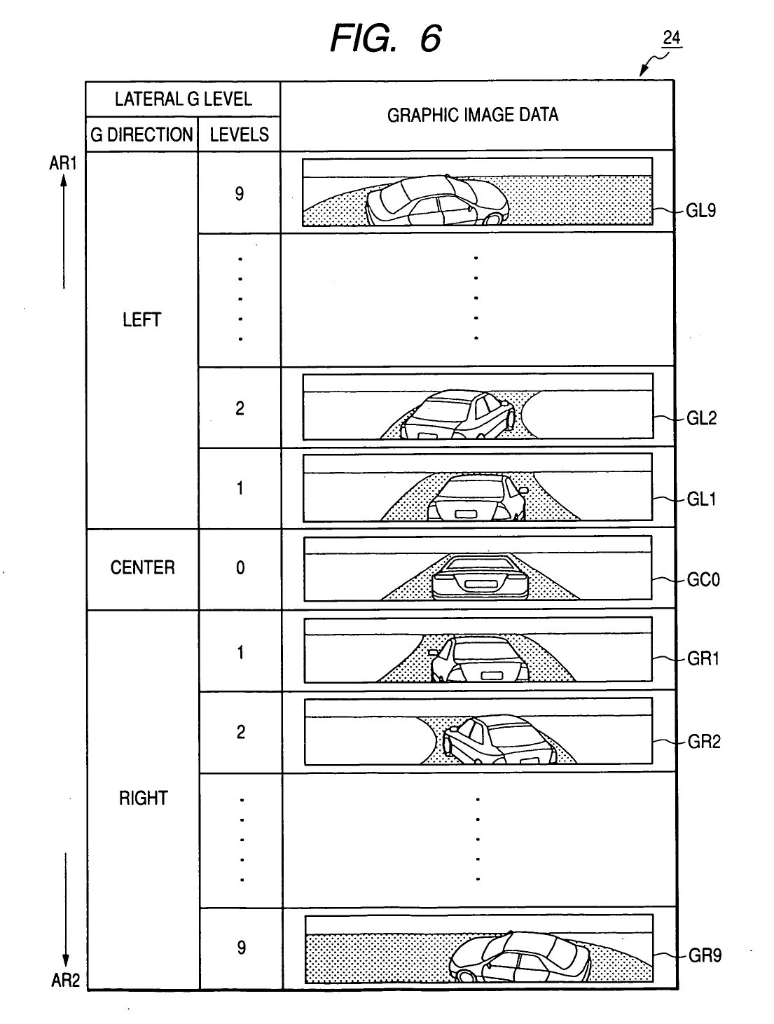

As shown in an example of the data configuration of FIG. 6, the G graphic pattern table 24 is a data table for storing a lateral G level and graphic image data correspondingly. According to FIG. 6, the lateral G level has a G direction and a level number. The G direction is the direction of the acceleration outputted from the information control unit 100, and there are three G directions of the left, center and right. The center of the G direction represents a state of having no lateral acceleration generated.

The level number is a level representing the size of acceleration. The CPU 10 divides a range of the acceleration (G) detectable by the acceleration detector 200 into a predetermined number (such as 19) in advance, and sets the divided accelerations as levels. For instance, it sets the acceleration size 0 G to 0.1 G as the level number “0,” 0.1 G to 0.2 G as the level number “2,” . . . 0.9 G to 1.0 G as the level number “9.” For the sake of convenience in description, the lateral G level will be described in the form of “G direction+level number,” such as “center 0” for the lateral G level of the G direction “center” and level number “0,” and “left 9” for the lateral G level of the G direction “left” and level number “9.”

The graphic image data is the image data for displaying the G graphic as a level display mode on the display unit 400. As shown in FIG. 6, the graphic image data stored in this embodiment displays graphics GL 1 to GL 9, GC 0, and GR 1 to GR 9 which are vehicle images projected from behind the vehicle having its inclination against its traveling direction changed according to the crosswise acceleration.

For instance, the G graphic GC 0 of FIG. 6 is displayed by the graphic image data of which lateral G level is corresponding to “center 0.” If the lateral G level is “left 1,” the G graphic GL 1 is displayed based on the corresponding graphic image data. And if the lateral G level is “left 2,” the G graphic GL 2 is displayed. Thus, the graphic image data is created so that, if the level number of the lateral G level of the G direction “left” becomes large, the vehicle inclines to the left against its traveling direction according to the level number.

If the lateral G level is “right 1,” the graphic GR 1 is displayed based on the corresponding graphic image data. And if the lateral G level is “right 2,” the graphic GR 2 is displayed. Thus, the graphic image data is created so that, if the level number of the lateral G level of the G direction “right” becomes large, the vehicle inclines to the right against its traveling direction according to the level number.

Therefore, it is possible to increment or decrement the level number sequentially, display the G graphic based on the graphic image data corresponding to the lateral G level of that level number and update the display of the G graphic sequentially so as to display a moving image as if the vehicle oscillates crosswise. A vehicle C on the G graphic in an arrow AR 1 direction of FIG. 6 is inclined further to the left side than the vehicle C on the G graphic in an arrow AR 2 direction. Therefore, a description will be given below on condition that the lateral G level in the arrow AR 1 direction is further to the left side than the lateral G level in the arrow AR 2 direction and the lateral G level in the arrow AR 2 direction is further to the right side than the lateral G level in the arrow AR 1 direction.

FIG. 5B is a diagram showing an example of the data configuration of the RAM 30. According to FIG. 5B, the RAM 30 has a currently detected lateral G level 31, a lastly displayed lateral G level 33, a currently displayed lateral G level 35, a right counter count-up value 37R, a left counter count-up value 37L, a right counter 39R and a left counter 39L stored therein.

The currently detected lateral G level 31 is the lateral G level of the acceleration outputted from the information control-unit 100. The CPU 10 updates the currently detected lateral G level 31 each time the direction and size of the crosswise acceleration are outputted from the information control unit 100.

The lastly displayed lateral G level 33 is the lateral G level for the G graphic displayed before updating the display of the display unit 400. The currently displayed lateral G level 35 is the lateral G level of the G graphic currently displayed on the display unit 400. The CPU 10 sets the right counter count-up value 37R and left counter count-up value 37L from the lastly displayed lateral G level 33 and currently displayed lateral G level 35. The lastly displayed lateral G level 33 and currently displayed lateral G level 35 are set to “center 0” on initialization.

The right counter count-up value 37R is a value representing a degree of time interval for updating the display of the G graphic in the case where the vehicle C in the displayed G graphic is inclined to the right, that is, in the case where the level number of the lateral G level of the G direction “left” decreases or the level number of the lateral G level of the G direction “right” increases. Therefore, it is possible, by setting the value of the right counter count-up value 37R larger, to slow the speed for updating the moving image transiting to incline the vehicle C to the right for a fixed period.

The left counter count-up value 37L is a value representing the degree of time interval for updating the display of the G graphic in the case where the vehicle C in the displayed G graphic is inclined to the left, that is, in the case where the level number of the lateral G level of the G direction “right” decreases or the level number of the lateral G level of the G direction “left” increases. Therefore, it is possible, by setting the value of the left counter count-up value 37L larger, to slow the speed for updating the moving image transiting to incline the vehicle C to the left for a fixed period. The CPU 10 implements suspension control means and update speed slowing control means with the right counter count-up value 37R and left counter count-up value 37L.

The right counter 39R is a counter value for, on inclining the vehicle C in the displayed G graphic to the right, determining whether or not the time interval equivalent to the right counter count-up value 37R has elapsed as the time interval until displaying a next G graphic.

The left counter 39L is the counter value for, on inclining the vehicle C in the displayed G graphic to the left, determining whether or not the time interval equivalent to the left counter count-up value 37L has elapsed as the time interval until displaying the next G graphic. The right counter 39R and left counter 39L are set to “1” on initialization.

Next, a concrete operation of the in-vehicle audio system 1 will be described by using the flowcharts of FIGS. 7 and 8. On detecting that the display mode is switched to the graphic mode by operating the input unit 500, the CPU 10 starts the G graphic control processing and repeatedly performs the processing. The G graphic control processing is performed every 100 ms in this embodiment to update the display of the G graphic with intervals of 100 ms basically. However, the time interval is changeable as appropriate. For instance, it may be set according to performance of the CPU 10 or set to an even shorter time interval so as to improve display accuracy of the G graphic.

First, the CPU 10 performs the processing of the steps S1 to S15 and thereby sets the values of the right counter count-up value 37R and left counter count-up value 37L. Either a short value or a long value may be set to the right counter count-up value 37R and left counter count-up value 37L. For instance, in the case where “1” is set as the short value, an update speed of the G graphic for movie-displaying the vehicle C in an inclined state is every 100 ms. In the case where the long value is set, the update speed of the G graphic for movie-displaying the vehicle C in the inclined state is every 500 ms.

The CPU 10 first obtains the currently displayed lateral G level 35 from the RAM 30 (step S1), and then sets “1” (short value) to each of the right counter count-up value 37R and left counter count-up value 37L (step S3).

Next, the CPU 10 determines whether or not the G direction of the currently displayed lateral G level 35 is “left” (step S5). If determined that the G direction of the currently displayed lateral G level 35 is “left” (step S5: Yes), the CPU 10 determines whether or not the currently displayed lateral G level 35 is further on the left side than the lastly displayed lateral G level 33 (step S7).

If determined that the currently displayed lateral G level 35 is further on the left side than the lastly displayed lateral G level 33 (step S7: Yes), that is, if the vehicle on the currently displayed G graphic is transiting in the state of inclining to the left side in reference to the center, the CPU 10 slows the update speed of the G graphic when the vehicle C returns inside the center direction. For this reason, the CPU 10 changes the right counter count-up value 37R from the short value to the long value (step S9).

If determined that the G direction of the currently displayed lateral G level 35 is not “left” in the step S5 (step S5: No) or if determined that the currently displayed lateral G level 35 is not further on the left side than the lastly displayed lateral G level 33 in the step S7 (step S7: No) or after the processing of the step S9, the CPU 10 determines whether or not the G direction of the currently displayed lateral G level 35 is “right” (step S11).

If determined that the G direction of the currently displayed lateral G level 35 is “right” (step S11: Yes), the CPU 10 determines whether or not the currently displayed lateral G level 35 is further on the right side than the lastly displayed lateral G level 33 (step S13).

If determined that the currently displayed lateral G level 35 is further on the right side than the lastly displayed lateral G level 33, that is, if the vehicle C on the currently displayed G graphic is transiting in the state of inclining to the right side in reference to the center, the CPU 10 slows the speed for updating the display of the G graphic on return of the vehicle C to the center. For this reason, the CPU 10 changes the left counter count-up value 37L from the short value to the long value (step S15).

Thus, in the G graphic control processing, it is determined, by the processing of the steps S1 to S15, how the vehicle C is transiting from the lastly displayed G graphic to the currently displayed G graphic. Depending on a result of the determination, an update interval of the G graphic is set longer when the vehicle C is heading from the center to outside of the left side and transits inside the center direction by having a leftward acceleration related to the vehicle reduced thereafter. And the update interval of the G graphic is set longer when the vehicle C is heading from the center to outside of the right side and transits inside the center direction by having a rightward acceleration related to the vehicle reduced thereafter.

After the processing of the step S15, the CPU 10 performs the processing of the step S17 onward, and updates the G graphic with the graphic image data corresponding to the lateral G level selected based on the result of comparing the currently detected lateral G level 31 with the currently displayed lateral G level 35. In this case, the CPU 10 updates the display of the respective G graphics in the case of having the vehicle C inclined inward toward the center from the left side and in the case of having the vehicle C inclined toward the center from the right side at the update speed according to the values of the right counter count-up value 37R and left counter count-up value 37L.

First, the CPU 10 decides the currently detected lateral G level 31 from the acceleration outputted from the information control unit 100, and stores it in the RAM 30 (step S17). And the CPU 10 compares the currently detected lateral G level 31 with the currently displayed lateral G level 35 so as to determine whether or not the level number has changed (step S19).

If determined that the level number has changed (step S19: Yes), the CPU 10 then determines whether or not the currently detected lateral G level 31 is further on the left side than the currently displayed lateral G level 35 (step S21). If determined that the currently detected lateral G level 31 is further on the left side (step S21: Yes), that is, in the case where the leftward (Y− direction) acceleration increases or the rightward (Y+ direction) acceleration decreases, the CPU 10 first resets the value of the right counter 39R (step S23).

Next, the CPU 10 increments (+1) the value of the left counter 39L (step S25), and then determines whether or not the left counter 39L is larger than the left counter count-up value 37L (step S27).

In this case, if the left counter count-up value 37L is set to “1” (short value) in the processing preceding the step S17, the CPU 10 determines that “2” of the left counter 39L is larger (step S27: Yes) and updates the display of the G graphic to have the inclination of the vehicle C transit leftward by the processing of the steps S29 to S33.

To be more specific, the CPU 10 first sets the currently displayed lateral G level 35 to the lastly displayed lateral G level 33 to update the RAM 30 (step S29) and resets the left counter 39L (step S31). And the CPU 10 updates the setting of the currently displayed lateral G level 35 further to the left by one (step S33), and thereby reads the graphic image data corresponding to the currently displayed lateral G level 35 from the G graphic pattern table 24 so as to have the G graphic based on the data displayed on the display unit 400.

However, if the left counter count-up value 37L is set to the long value “5” in the processing preceding the step S17, the CPU 10 determines that the left counter 39L is smaller (step S27: No) and finishes the G graphic control processing. And if determined, by repeatedly performing the G graphic control processing, that the left counter 39L is larger than the left counter count-up value 37L due to the increment of the left counter 39L in the processing of the step S25 (step S27: Yes), the CPU 10 performs the processing of the steps S29 to S33 and updates the display to incline the vehicle C of the G graphic leftward.

Therefore, when the vehicle C transits outward to incline rightward from the center, the display of the G graphic is immediately updated per 100 ms because the right counter count-up value 37R is the short value. When vehicle C transits inward to incline toward the center from the right side, the left counter count-up value 37L is set to the long value so that the display of the G graphic is suspended until the left counter 39L reaches “5,” that is, for 500 ms.

Thus, if determined that the currently displayed lateral G level 35 is further on the right side than the lastly displayed lateral G level 33 in the step S13 and that the currently detected lateral G level 31 is further on the left side than the currently displayed lateral G level 35 in the step S21, the CPU 10 determines that the state of change in the rightward (Y+ direction) acceleration has reached the maximum and suspends the G graphic. Thus, the determination means and suspension control means are implemented.

If determined that the currently detected lateral G level 31 is not further on the left side than the currently displayed lateral G level 35 in the step S21 (step S21: No), that is, in the case where the rightward (Y+ direction) acceleration increases or the leftward (Y− direction) acceleration decreases, the CPU 10 first resets the value of the left counter 39L (step S35).

Next, the CPU 10 increments (+1) the value of the right counter 39R (step S37), and then determines whether or not the right counter 39R is larger than the right counter count-up value 37R (step S39).

In this case, if the right counter count-up value 37R is set to “1” (short value) in the processing preceding the step S17, the CPU 10 determines that “2” of the right counter 39R is larger (step S39: Yes) and updates the display of the G graphic to incline the vehicle C rightward by the processing of the steps S41 to S45.

To be more specific, the CPU 10 first sets the currently displayed lateral G level 35 to the lastly displayed lateral G level 33 to update the RAM 30 (step S41) and resets the right counter 39R (step S43). And the CPU 10 sets the currently displayed lateral G level 35 further to the right by one (step S45).

However, if the right counter count-up value 37R is set to the long value “5” in the processing preceding the step S17, the CPU 10 determines that the right counter 39R is smaller (step S39: No) and finishes the graphic control processing. And if determined, after repeatedly performing the G graphic control processing, that the right counter 39R is larger than the right counter count-up value 37R due to the increment of the right counter 39R in the processing of the step S37, the CPU 10 performs the processing of the steps S41 to S45 and updates the display to have the vehicle C of the G graphic transit rightward.

Therefore, when vehicle transits outward to incline leftward from the center, the display of the G graphic is immediately updated per 100 ms because the left counter count-up value 37L is the short value. When the vehicle C inclines inward from the left side of the center, the right counter count-up value 37R is set to the long value so that the display of the G graphic is suspended until the right counter 39R reaches “5,” that is, for 500 ms.

Thus, if determined that the currently displayed lateral G level 35 is further on the left side than the lastly displayed lateral G level 33 in the step S7 and that the currently detected lateral G level 31 is further on the right side than the currently displayed lateral G level 35 in the step S21, the CPU 10 determines that the state of change in the leftward (Y− direction) acceleration has reached the maximum and suspends the G graphic.

If determined that the level number has changed in the step S19, the CPU 10 resets the values of the left counter 39L and right counter 39R (steps S47 to S49) and finishes the G graphic control processing.

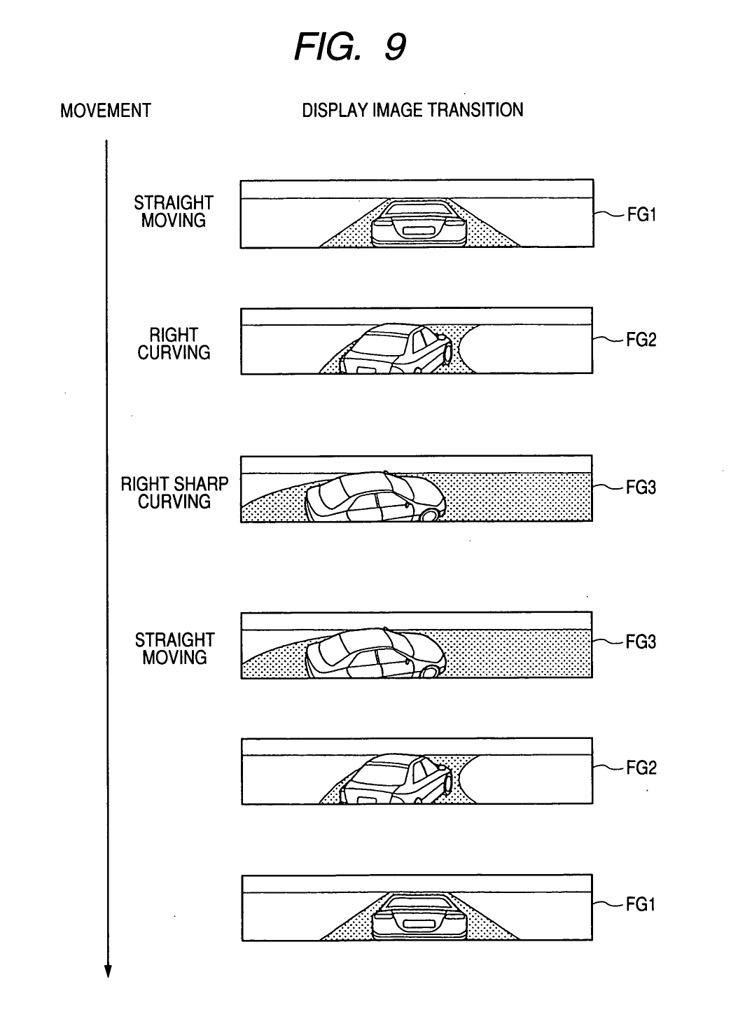

Next, a description will be given as to a concrete operation example of the in-vehicle audio system 1 by using FIG. 9 representing a relation between a traveling state of the vehicle and a display example of screen transition of the display unit 400.

First, while the vehicle is moving straight, no lateral acceleration is detected by the acceleration detector 200. During this time, the display unit 400 displays a G graphic FG1 in which the vehicle is moving straight. And if the vehicle curves to the right, the lateral G level is decided as “left 2” based on the leftward acceleration detected by the acceleration detector 200, and a G graphic FG2 is displayed on the display unit 400.

Furthermore, if the vehicle sharply curves to the right, a G graphic FG3 is displayed. Thus, it is possible to display the state of change in the acceleration lucidly by updating the G graphic consecutively according to the acceleration exerted on the vehicle.

And when the vehicle moves straight after sharply curving, the image on the display unit 400 suspends for about 500 ms while remaining as the G graphic FG3 of FIG. 9. After that suspension, the display on the display unit 400 transits through the G graphics FG2 and FG1 and returns to the image in which the vehicle is moving straight.

In general, when the acceleration related to the vehicle reaches the highest point, the driver is concentrated on driving so that the display unit 400 cannot be checked. Thus, immediately after the acceleration reaches the maximum as after the sharp curving of FIG. 9, it is possible to have the driver see the state of change in the acceleration of the vehicle anew after the sharp curving by suspending and then restarting the display update of the G graphic.

As described above, according to this embodiment, the lateral G level is decided from the acceleration detected by the acceleration detector 200, and the graphic image data according to the decided lateral G level is selected so as to display the image based on the data at any time. It is thereby possible to movie-display the state of change in the crosswise acceleration exerted on the vehicle. Therefore, the driver can easily know the change in the crosswise acceleration related to the vehicle by means of the movie display.

If determined that the rightward or leftward acceleration exerted on the vehicle reaches the maximum for changing from ascent to descent and the vehicle transits inward, control is exerted to suspend the update of the G graphic. Therefore, the changing state of the acceleration exerted in reality is suspended and then restarted so that the driver can enjoy the state of change in the acceleration with the G graphic of which display is updated to follow the driver's driving.

<Modification of the Embodiment>

According to the above-mentioned embodiment, a graphic display is updated according to the acceleration in the Y (lateral) direction outputted from the acceleration detector 200. It is a matter of course, however, that the same effects can be obtained by updating the display according to the acceleration in the X (vertical) direction.

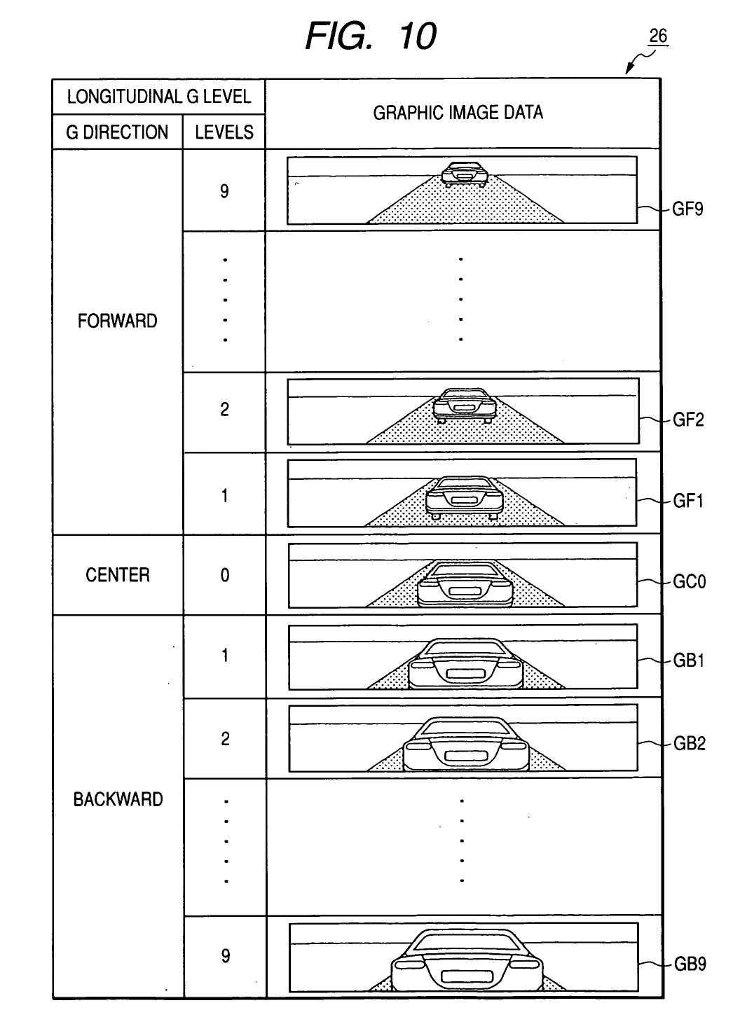

FIG. 10 is a diagram showing a data configuration example of a G graphic pattern table 26 used when updating the display according to the acceleration in the vertical direction. According to FIG. 10, the G graphic pattern table 26 stores a vertical G level and the graphic image data by associating them with each other. The vertical G level is configured by including the G direction and the level number.

As for the G direction of the G graphic pattern table 26, there are three directions of forward, center and backward. The CPU 10 decides the vertical G level of the acceleration outputted from the information control unit 100 by the same method as the above-mentioned lateral G level. The G graphic based on the graphic image data of the G graphic pattern table 26 is a vehicle image having a display size of the vehicle changed according to the longitudinal acceleration as in FIG. 10.

The CPU 10 performs the G graphic control processing by using the G graphic pattern table 26. The G graphic control processing in this case is substitutable by replacing the G graphic control processing of FIGS. 7 and 8 by the processing for the vertical acceleration, such as the right counter count-up value of the G graphic control processing of FIGS. 7 and 8 by a forward counter count-up value, the left counter count-up value by a backward counter count-up value, the right counter by a forward counter, the left counter by a backward counter, and the lateral G level by the vertical G level.

For this reason, as the G graphic control processing is performed by using the G graphic pattern table 26 of FIG. 10, there is a change, on accelerating the vehicle forward, that is, when the driver steps on the accelerator, that the vehicle gradually moves away forward and becomes smaller as shown in the G graphics GC 0 to GF 1 up to GF 9. And there is a change, on accelerating the vehicle backward, that is, when the driver steps on the brake, that the vehicle gradually comes closer and becomes larger as shown in the G graphics GB1 to GB 9.

In the case where the acceleration decreases after accelerating forward and becomes constant-speed driving, the CPU 10 detects the decrease and determines that the acceleration has reached the maximum so as to suspend the G graphic. In the case where the acceleration decreases after accelerating backward and becomes constant-speed driving, the CPU 10 also suspends the G graphic. Thus, immediately after the driver steps on the accelerator or the brake, the display of the G graphic is suspended and then the display update of the G graphic is restarted to follow the driver's driving as with the above-mentioned embodiment. Therefore, the driver can check the state of change in the vertical acceleration anew after stepping on the accelerator or the brake.

It is also possible, by combining the G graphic control processing for the vertical acceleration with the G graphic control processing for the lateral acceleration, to exert control to update the display of the G graphic according to the vertical and lateral accelerations respectively. In this case, the G graphic pattern table is used for the sake of storing the lateral G level, vertical G level and graphic image data by associating them with one another. For instance, the lateral G level “left 9” is associated with 19 kinds of vertical G levels shown in FIG. 10. As for the 19 kinds of vertical G levels, the graphic image data for expanding or reducing the graphic GL 9 of FIG. 6 according to the vertical G level is created and associated therewith.

Thus, in the case where the driver curves to the right while accelerating forward by stepping on the accelerator for instance, the display unit 400 shows the vehicle which is small as in the G graphic GF 9 of FIG. 10 and significantly inclined to the left as in the G graphic GL 9 of FIG. 6. Therefore, it is possible to implement a more realistic display of the G graphic against driving performance.

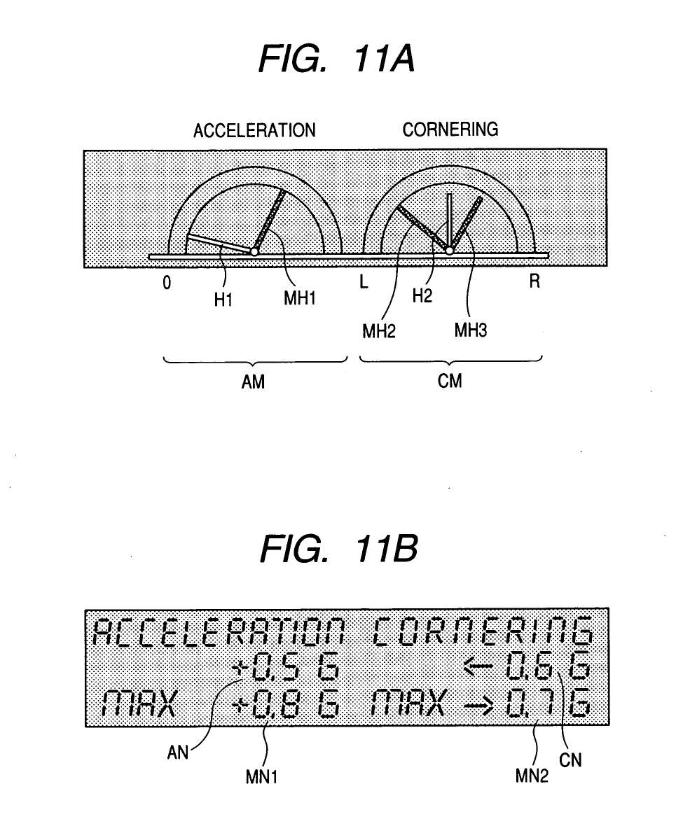

The display update of the G graphic is displayed in a level display mode of the vehicle such as FIG. 6 or FIG. 10. However, the display method is not limited thereto but is changeable as appropriate. For instance, the level display mode may be a meter-like image as shown in FIG. 11A.

FIG. 11A shows a vertical analog meter AM for representing the state of change in the vertical acceleration and a lateral analog meter CM for representing the state of change in the lateral acceleration. The vertical analog meter AM indicates the current state of change in the vertical acceleration by deflection of a pointer H1. As with the above-mentioned embodiment, the pointer H1 exerts control to suspend the display update in the case where the acceleration has reached the maximum. When the state of change in the vertical acceleration has reached the maximum, the acceleration is indicated by a maximum pointer MH1.

A pointer H2 of the lateral analog meter CM indicates the leftward acceleration by leftward deflection and the rightward acceleration by rightward deflection. In the case where the acceleration is exerted neither leftward nor rightward, the pointer H2 points to the center of the lateral analog meter CM as in FIG. 11A. As with the above-mentioned embodiment, the pointer H2 also exerts control to suspend the display update in the case where the acceleration has reached the maximum. When the state of change in the crosswise acceleration has reached the maximum, the acceleration is indicated by maximum pointers MH2 and MH3.

It is also possible, as in FIG. 11B, to display the state of change in the acceleration as a numerical image for instance. According to FIG. 11B, the state of change in the vertical acceleration is represented as a current acceleration AN, and the state of change in the lateral acceleration is represented as a current acceleration CN. In the case where the vertical and lateral accelerations have reached the maximum as in FIG. 11A, the accelerations at the maximum are indicated as maximum accelerations MN1 and MN2. In the case where the acceleration has reached the maximum, the indications of the current accelerations AN and CN are suspended.

Thus, it is possible to display the level display mode by a number of variations such as the vehicle image, analog meter image and numerical image. Therefore, it is possible to set the display mode to fit with the user's taste.

Each of the right counter count-up value 37R and left counter count-up value 37L of the G graphic control processing shown in FIGS. 7 and 8 is set to either the short value or the long value. However, it is also possible to perform the following.

To be more specific, if determined that the currently displayed lateral G level 35 is further on the left side than the lastly displayed lateral G level 33 in the step S7, a middle value (such as “2”) is set to the right counter count-up value 37R when the vehicle further on the left side than the currently displayed center inclines further to the right from the last display.

If determined that the currently displayed lateral G level 35 is further on the right side than the lastly displayed lateral G level 33 in the step S13, that is, when the vehicle further on the right side than the currently displayed center inclines further to the left from the last display, the middle value is set to the left counter count-up value 37L.

As the right counter count-up value 37R and left counter count-up value 37L have the middle value set thereto, the display of the G graphic is updated per 200 ms when the leftward (Y− direction) acceleration of the vehicle decreases and the vehicle is returning to the center from the left side. Thus, it is possible, when the vehicle transits inward, to display the moving image thereof as if in slow motion so as to implement the update speed slowing control means.

Therefore, as with the above-mentioned embodiment, the moving image of the vehicle is suspended when the acceleration reaches the maximum, and the vehicle slowly transits toward the center thereafter. Thus, it is possible, after sharply curving to the right or left for instance, to prevent the user from missing the state of change in the acceleration immediately after the sharp curving and further check the state of change securely.

It is not necessary to detect the crosswise and longitudinal accelerations by a method of detecting a control angle of a steering wheel and detecting the crosswise acceleration from that control angle or detecting the longitudinal acceleration from rotation speed of a rotation axis. Therefore, there is no need to provide special wiring and the like to a steering wheel mechanism or the axle of the vehicle when implementing this embodiment. For this reason, the user can easily check the state of change in the acceleration just by installing the in-vehicle audio system 1 in the vehicle.

It is also possible to exert control in conjunction with various operation units according to the state of change in the acceleration. To be more precise, it is also possible to implement audio output means for controlling the audio play back control unit 50 and outputting the audio according to the state of change in the acceleration from the audio output unit 52. For instance, it is possible to inform the user of a rapid acceleration being performed by outputting an alarm in timing when a rate of change of the acceleration reaches a predetermined value. It is also possible to audio-output the value of the acceleration periodically.

It is also possible, for instance, to control the display of the G graphic based on the position information obtained by the GPS unit 72 mounted on a car navigation device. To be more precise, the CPU 10 for implementing obtaining means obtains the position information from the GPS unit 72 via the communication unit 70, and calculates the speed of the vehicle from the change in the position information. And it is also possible to output the image of a landscape changing at a speed according to the calculated speed on the G graphic. It is thereby possible to render the G graphic more realistic as the moving image. It is also possible, from the position information obtained from the GPS unit 72, to obtain geographical information on buildings and intersections located around the position of the vehicle currently running from the car navigation device so as to output the buildings and intersections on the G graphic.

It is also possible to store the acceleration outputted from the information control unit 100 in the external memory medium 62. For instance, it is possible to store the position information obtained by the GPS unit 72 and the acceleration outputted from the information control unit 100 by associating them with each other so as to implement position information storing means. Thus, after finishing the driving, the user can know where and how the acceleration changed.

It is also possible to implement comment attaching means for storing the acceleration by associating therewith a comment according to the state of change in the acceleration as detection time information. For instance, it is possible to store the detection time information such as date and time and place name inputted by the operation of the input unit 500 in the external memory medium 62 by associating it with the acceleration outputted from the acceleration detector 200. It is also possible to store this comment by automatically associating the acceleration therewith. For instance, it is possible to output the alarm via the audio output unit 52 when the acceleration reaches the maximum, and store the position information obtained by the GPS unit 72 and the acceleration of the highest point thereof in the external memory medium 62 by associating them with each other in the case where the operation of the input unit 500 is detected. For this reason, the user can know the location where the acceleration reached the maximum after finishing the driving from the position information and the acceleration stored in the external memory medium 62.

It is also possible to implement transfer means by transferring the acceleration outputted from the information control unit 100 to the external device such as a personal computer capable of data processing via the communication unit 70. Thus, it becomes possible to display-output the state of change in the acceleration of the vehicle and perform various analytical processing with the personal computer.

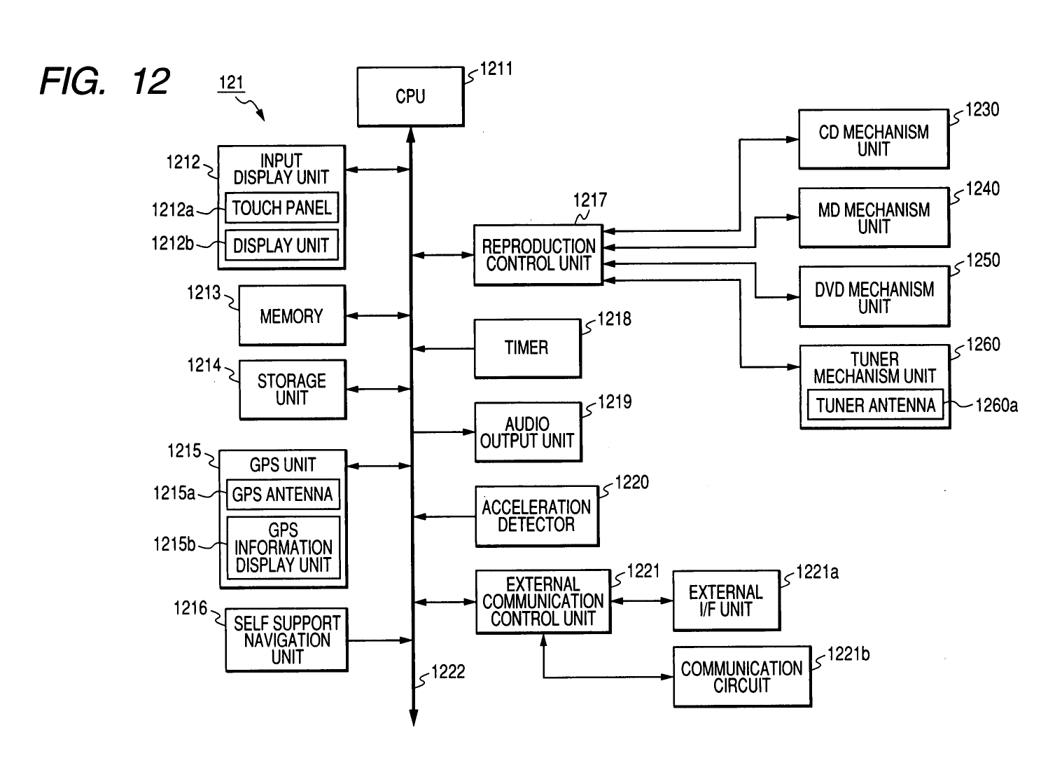

According to the second aspect of the present invention, it is possible to add up and display the acceleration points according to the acceleration exerted on the in-vehicle device per unit time and visually inform the driver of driving characteristics easily. FIGS. 12 to 18 show an example of the in-vehicle display device.

FIG. 12 is a block diagram showing the functional configuration of an in-vehicle device 121 of the embodiment according to the second aspect. As shown in FIG. 12, the in-vehicle device 121 comprises a CPU (Central Processing Unit) 1211, an input display unit 1212, a memory 1213, a storage unit 1214, a GPS unit 1215, a self navigation unit 1216, a reproduction control unit 1217, a timer 1218, an audio output unit 1219, an acceleration detector 1220 and an external communication control unit 1221, where the units are electrically connected to one another by a bus 1222.

The CPU 1211 comprises internal RAM (Random Access Memory), ROM (Read Only Memory) and so on not shown in particular. The CPU uses a predetermined area of the internal RAM as a work area, and transmits control signals to the units according to various control programs and various kinds of data stored in the ROM so as to control overall operations of the in-vehicle device 121. A storage destination of the above-mentioned work area and programs may be the memory 1213 or the storage unit 1214 which will be described later.

The input display unit 1212 as display means is configured by including a touch panel 1212a and a display unit 1212b.

The touch panel 1212a is the input unit for functioning as unit time setting means or changing means of a pressure-sensitive method (resistance film pressure method) having transparent electrodes placed therein. It is placed by being superposed on the display screen of the display unit 1212b, and is integrated with the display unit 1212b.

The image and various buttons displayed on the display unit 1212b are visible through the touch, panel 1212a. The touch panel 1212a detects position coordinates of a point pushed by a finger or the like as a voltage value, and outputs it as push position data to the CPU 1211.

The display unit 1212b is configured by an LCD, an LED (Light Emitting Diode), an FL (Fluorescent Display) or the like, and displays various kinds of display data according to the display control signal inputted from the CPU 1211.

The memory 1213 is configured by the RAM or the like, and forms the work area for temporarily storing various programs executed by the CPU 1211 and the data processed by the programs.

The storage unit 1214 as the storing means comprises a nonvolatile memory and a memory medium having the programs and data stored therein in advance (not shown in particular). It stores the data such as various operation control programs, the acceleration points, geographical information and various setting information corresponding to the in-vehicle device 121 in the memory medium, and outputs the stored data to the CPU 1211 on having an address specified.

The GPS unit 1215 as current position detecting means comprises a GPS antenna 1215a, and receives a GPS signal transmitted from a GPS satellite launched into low earth orbit. It detects an absolute current position (latitude and longitude) of the vehicle based on the received GPS signal, and outputs it to the CPU 1211. A GPS information display unit 1215b is configured by the LCD or the like, and displays the display data outputted from the CPU 1211 on the screen.

The CPU 1211 calculates map data indicating the current position based on the position information from the GPS unit 1215 and the geographical information stored in the storage unit 1214, and outputs it as the display data to the GPS information display unit 1215b to display the map indicating the current position on the screen.

The self navigation unit 1216 calculates an amount of change in the traveling direction based on an angular speed (horizontal rotation speed per unit time) of the vehicle detected by the acceleration detector 1220 described later so as to calculate a travel distance of the vehicle based on a pulse signal outputted according to the rotation of the steering wheel. The self navigation unit 1216 calculates a relative position change of the vehicle based on the calculated angular speed and travel distance so as to output it to the CPU 1211.

The reproduction control unit 1217 controls a CD mechanism unit 1230, an MD mechanism unit 1240, a DVD mechanism unit 1250 and a tuner mechanism unit 1260 and thereby performs reproduction control of the sources of the CD, MD, DVD and a radio broadcast received by a tuner antenna 1260a and so on to output the sound signals to the audio output unit 1219 which will be described later so as to have them enunciated.

The timer 1218 as timing means has a crystal-oscillator circuit for outputting clock signals of crystal-oscillation at a constantly fixed frequency and a timing circuit for counting the clock signals and thereby timing the current time (neither is shown). It outputs timed time data to the CPU 1211 in the case of measuring the time.

The audio output unit 1219 is configured by a speaker, a D/A converter and an amplifier (none of them is shown) and so on, and converts a digital sound signal to an analog signal with the D/A converter according to an audio output instruction signal from the CPU 1211 or the reproduction control unit 1217 so as to amplify it to a predetermined sound volume with the amplifier and output it as the audio from a speaker.

The acceleration detector 1220 detects the acceleration exerted on the in-vehicle device 121 by various methods such as a piezo-electric method, a capacitance method and a piezo-resistive method. To be more precise, the acceleration detector 1220 comprises two pendulums (not shown in particular) for swinging in an x direction (crosswise) and in a y direction (traveling direction) inside respectively. It outputs the voltage value corresponding to the movement of the pendulums to the CPU 1211. Thus, the CPU 1211 can calculate the acceleration exerted to the in-vehicle device 121 based on the voltage value outputted from the acceleration detector 1220.

The external communication control unit 1221 comprises an external I/F unit 1221a and a communication circuit 1221b, and controls transmission and reception of the data to and from the external devices. The external I/F unit 1221a has joining terminals for performing data communication with the external devices according to various communication standards such as USB (Universal Serial Bus) and a mounting unit for detachably mounting a memory card (neither is shown) so as to perform the data communication with various information devices such as a PDA (Personal Digital Assistant) and a PC (Personal Computer).

A communication circuit 1221b as receiving means is configured by a circuit for performing infrared data communication such as IrDA (Infrared Data Association) and a circuit for performing radio communication with a wireless IC tag (neither is shown). It transmits and receives the data to and from an external terminal such as a cellular phone and a noncontact IC card. To be more precise, the communication circuit 1221b receives a user identifying ID from the cellular phone held by the user, and outputs it to the CPU 1211. The CPU 1211 reads operation history data and device setting data stored in the storage unit 1214 per user according to the ID.

Next, the operation according to this embodiment will be described.

The programs for implementing the functions described in the flowcharts to be described later are stored in the storage unit 1214 in the form of readable program code, and the CPU 1211 consecutively performs the operations according to the program code. The CPU 1211 can also perform the operations consecutively according to the program code transmitted from outside via the external I/F unit 1221a. To be more specific, it is also possible to implement the operations unique to this embodiment by using the program or data externally supplied in addition to the programs stored in the in-vehicle device 121.

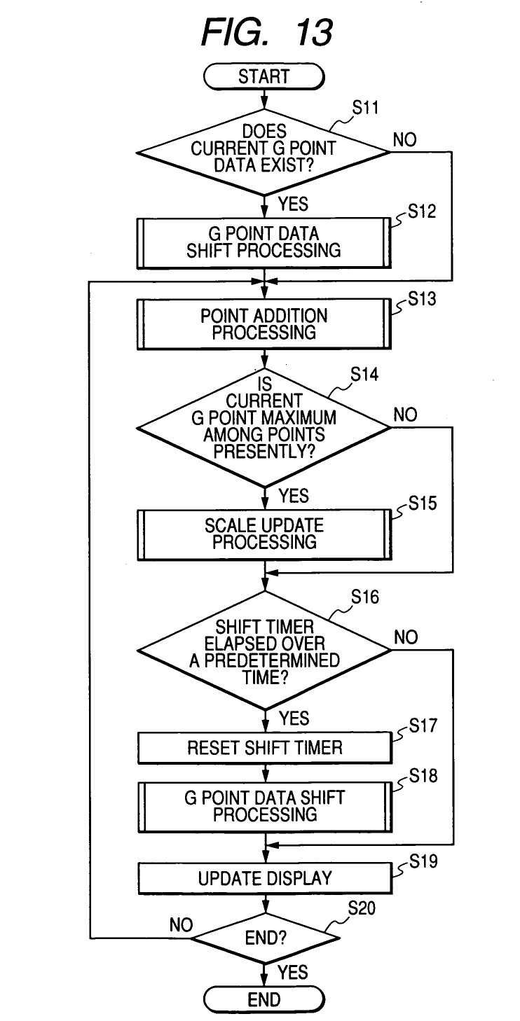

FIG. 13 is a flowchart showing operational processing according to this embodiment started on starting energization (on turning a starting key of the vehicle to an “ACC ON” position) of the in-vehicle display device and on turning on a power switch and executed by the CPU 1211.

If the operations are started, the CPU 1211 determines whether or not current G point data is stored in the storage unit 1214 (step S11). If it exists, the CPU 1211 moves on to G point data shift processing (step S12). If it does not exist, the CPU 1211 moves on to point addition processing as acceleration calculating means (step S13).

The G point data as the acceleration point is the information on added-up accelerations, consists of the current G point data currently being added and the G point data added in the past, and is configured by storing a predetermined number of pieces of data added in the past in historical order from the present.

According to the step S11, it is possible to determine whether or not to perform the processing relating to the display of past acceleration history depending on the case where there is the information on the accelerations added up by measurement by the last time in the storage unit 1214 and the case where the data is reset and there is no information on the accelerations.

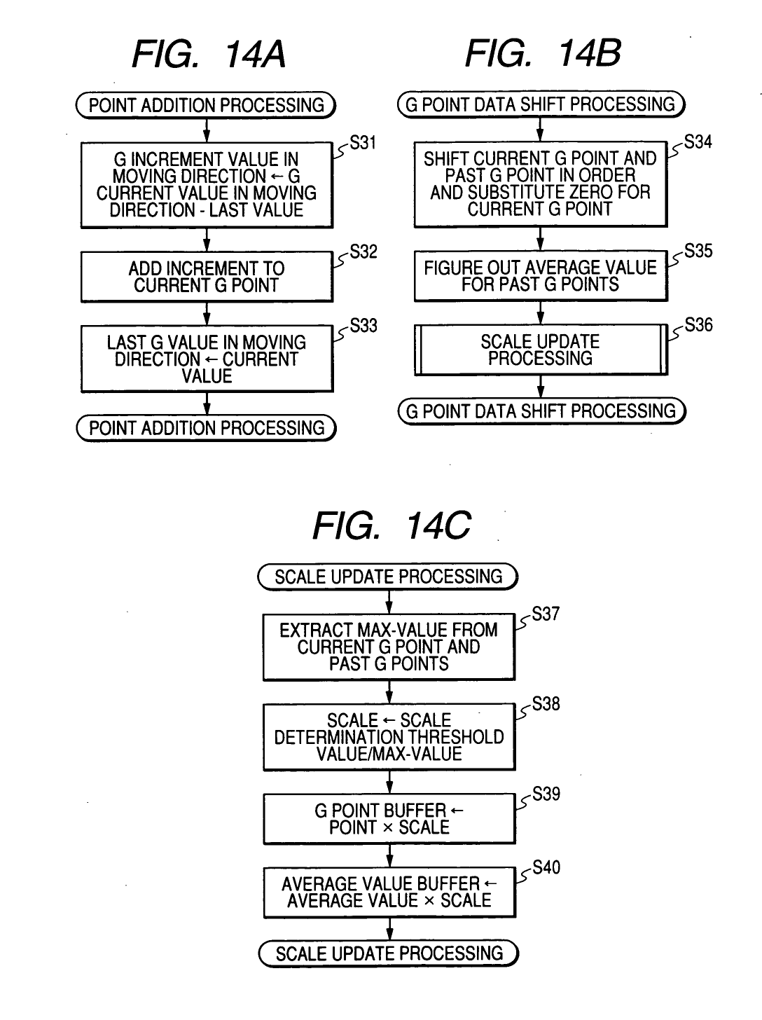

FIG. 14B shows the G point data shift processing performed in the case of determining that the G point data exists in the step S11 (step S11: Yes). The CPU 1211 shifts the data on the current G point and past G points stored in the storage unit 1214 in order, and substitutes 0 for a buffer relating to the current G point (step S34). The buffer referred to here is the data temporarily stored on the memory 1213 for the sake of performing the data calculation and display.

After the step S34, an average is calculated from the data on the past G points and stored in an average buffer by a step S35 as average calculating means, and scale update processing is performed (step S36) to finish a subroutine relating to the G point data shift processing.

The scale update processing performed in the step S36 is the process for deciding a scale on displaying the data on a graph, which is performed according to the flowchart shown in FIG. 14C.

On starting the scale update processing, the CPU 1211 extracts the maximum value out of the current G point and past G points (step S37), and calculates a scale value as (scale determination threshold value)/(extracted maximum value) (step S38). The scale determination threshold value referred to in this case is an upper limit on displaying the graph, which is preset by the number of pixels in a graph display direction or the like on the display unit 1212b.

After the step S38, the data on a display buffer relating to the G points in the memory 1213 is calculated as to all the past G point values stored as G point value x scale value (step S39), and the data on the display buffer relating to the average of the G points is calculated as average value x scale value (step S40) to finish the subroutine relating to the scale update processing.

It is possible to store the past acceleration data in historical order by the above-mentioned G point data shift processing. It is also possible, on graphically displaying the acceleration data, to display it on a proper scale by the scale update processing so as to put the graph within the display area in reference to the maximum acceleration value.

Next, a description will be given by referring to FIG. 14A as to the point addition processing (step S13) performed after the step S11 or the step S12. First, the CPU 1211 calculates an increase in the value of G in the traveling direction by subtracting the value measured last time from the value of G in the traveling direction measured this time (step S31). The value of G in the traveling direction in this case is a value according to the acceleration of a traveling direction component detected by the acceleration detector 1220.

After the step S31, the value according to the increase is added to the current G point value (step S32), and the value of G in the traveling direction measured this time is stored as the value measured last time (step S33) to finish the subroutine relating to the point addition processing. As for the value added in the step S32, the value according to the increase in the acceleration is stored as an LUT (Look Up Table) in the storage unit 1214 in advance, and that value is referred to and obtained. As for the value to be concretely stored in the LUT, it may be a configuration in which points to be given increase as the increase becomes larger, fuel consumption according to the increase in the acceleration measured in advance and obtained, or the like. It may also be the configuration in which the value to be stored in the LUT is inputted from the touch panel 1212a to be preset.

It is possible, by the above-mentioned point addition processing, to add the points according to the amount of change in the acceleration as the G point. For instance, it is possible, by performing this process at predetermined intervals, to obtain the G point according to the change in the acceleration per unit time so as to obtain driving characteristics of the driver such as the acceleration and deceleration by rendering them as points. It is also possible to convert the G point to the fuel consumption and thereby calculate the fuel consumption according to the change in the acceleration.

After the step S13, it is determined whether or not the current G point data is the largest of the G point data including the past G point data (step S14). In the case where it is the largest, the aforementioned scale update processing is performed (step S15), and the scale of the graph is changed to fit the current G point data.

After it is determined that the change of the scale is not necessary in the step S15 or step S14 (step S14: No), it is determined whether or not a shift timer has exceeded a stipulated time (step S16). If exceeded (step S16: Yes), the aforementioned G point data shift processing is performed (step S18) after resetting a shift timer value (step S17). The shift timer value in this case is the value for counting the time interval for performing the G point data shift processing, which may be set to a desired value from the touch panel 1212a by the user.

After it is determined that the shift timer has not exceeded the stipulated time in the step S16 (step S16: No), the display on the display unit 1212b is updated based on the data on the display buffer (step S19), and it is determined whether to finish the processing or render the processing of the steps S13 to S19 as a loop (step S20). It is possible, by adjusting the intervals of the determination of the steps S20, to adjust the timing of the processing of the steps S13 to S19 (timing of G point addition).

It may also be the configuration wherein, in the case where the current G point data exceeds the average in the step S19, the display is updated and also an alarm such as a beep is sounded from the audio output unit 1219 as warning means. In this case, it is possible to know that the acceleration points have exceeded the average without bothering to check the display unit 1212b so that the driver can concentrate on the driving.

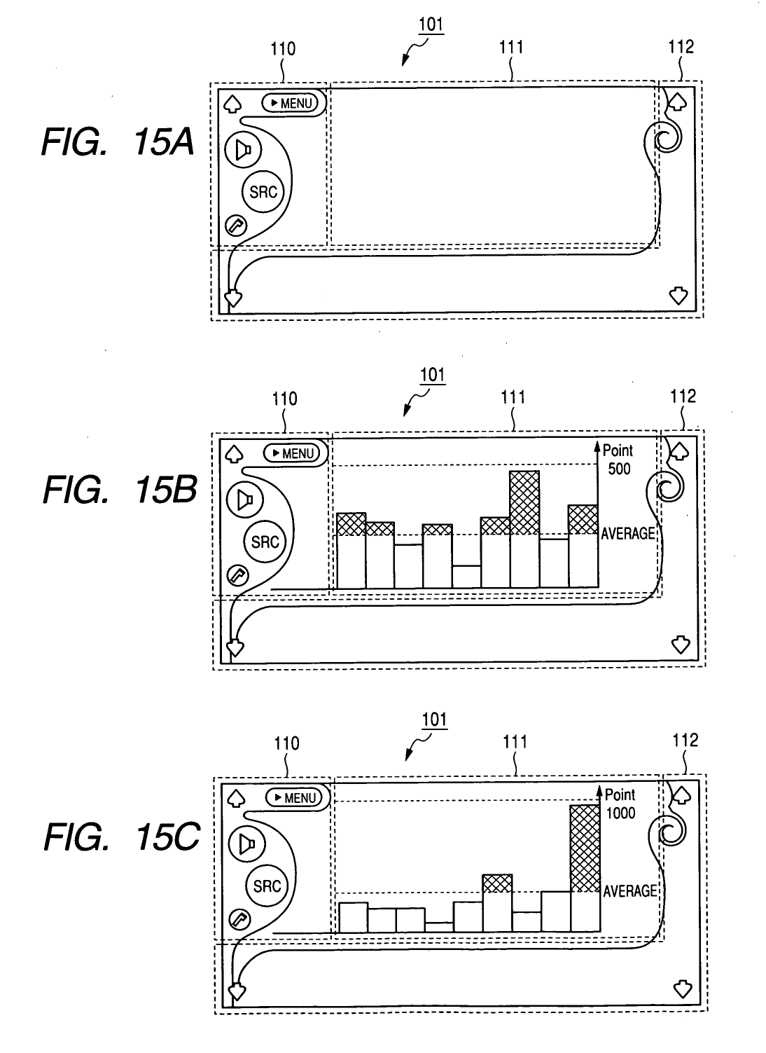

Here, a description will be given by referring to FIGS. 15 to 17 as to a display example on the display unit 1212b by the above-mentioned processing. FIG. 15 is a diagram showing a display screen 101 on the input display unit 1212. As shown in FIG. 15A, a display screen 101 is configured by a main display unit 111 for displaying main information, a sub display unit 112 for displaying supplementary information, and an operating unit 110 operable by the touch panel 1212a.

FIG. 15B is a diagram exemplifying the state of the main display unit 111 in the case where the largest points are around 500, and FIG. 15C is a diagram exemplifying the state of the main display unit 111 in the case where the largest points are around 1,000.

As shown in FIGS. 15B and 15C, the main display unit 111 displays the graph and averages, where the scale of the graph changes according to the largest points. The display on the main display unit 111 may have a different color as to the graph data portion equal to or larger than the average. In this case, the screen display of the step S19 is performed by changing the color of the display area equal to or larger than the average based on the value stored in the display buffer relating to the average calculated in the step S40.

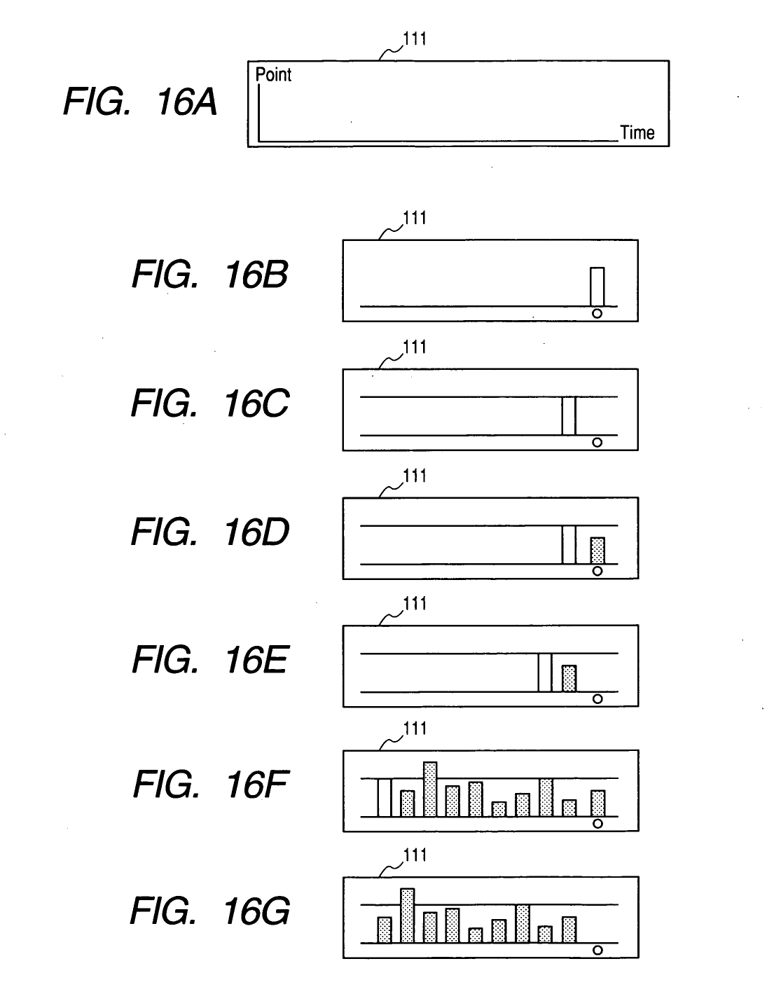

FIGS. 16 are diagrams showing display examples of graphs indicating point values as a vertical axis of the main display unit 111 and time as a horizontal axis thereof, where FIGS. 16B to 16G are show the state of having the G points sequentially added as time elapses. As shown in FIGS. 16, the main display unit 111 has the G point measured by the time interval of the shift timer added to the “;” portion of FIGS. 16 as the current G point data. The graphical display is shifted as the time set by the shift timer in the G point data shift processing elapses.

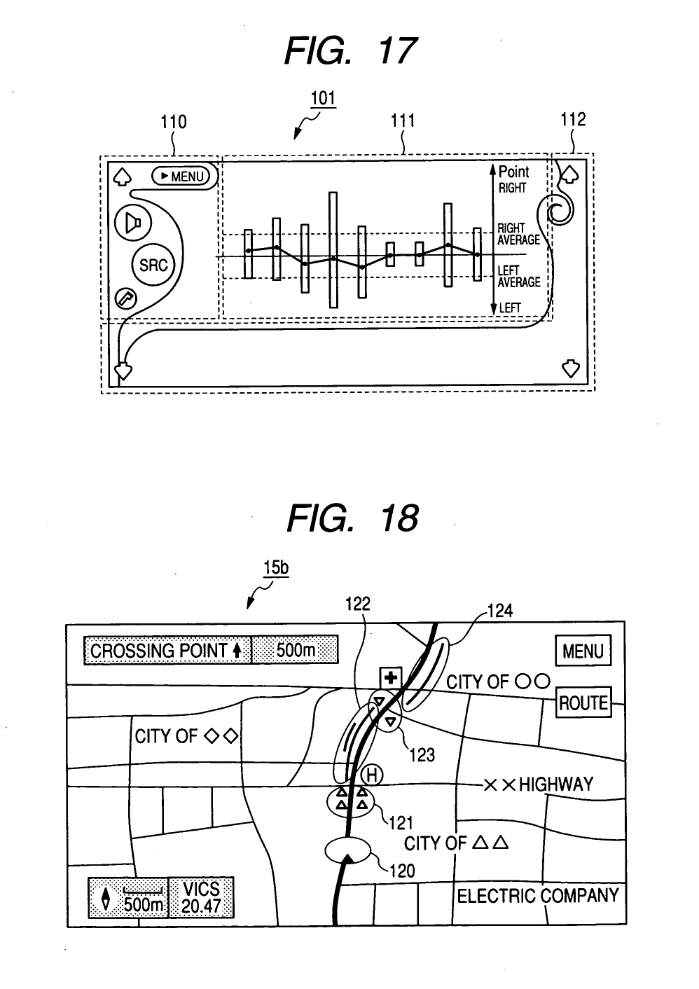

As shown in FIG. 17, the G point data may be that in the case of measuring the acceleration or deceleration in the traveling direction. However, it may also detect and display the acceleration exerted in the crosswise direction.

As described above, the in-vehicle device 121 can render the detected acceleration information as the points and add and display the points at the predetermined time interval to check the driving characteristics of the driver easily. Multiple pieces of point information measured in the past are graphically displayed so as to check them in comparison with the past driving characteristics. It is also possible, by displaying the averages based on the past point information, to easily know whether or not the driving has been rougher than usual.

As the graphical display is sequentially updated, it is possible to check the driving characteristics which are more practical. Furthermore, the scale of the graphical display is changed according to the maximum value of the displayed point information, and so it is possible to view a relative state of all the point values accurately.

The shift timer is settable according to the user's preference so as to be set suitably for the user often driving the vehicle over a relatively long distance or long time or the user driving the vehicle for commuting. According to this embodiment, the acceleration information added up at a predetermined time is displayed. It is also possible, however, to add it up at every interval between fueling and next fueling for instance. In this case, the acceleration information on fueling once can be checked, and so it is easy to check influence of the driving characteristics on the fuel consumption and so on.

<Modification of the Embodiment>

Next, description will be given as to the case of displaying and checking the acceleration information and position information as a deformed example of the display mode of the above-mentioned G point. As for this case, in the step S32, the position information detected by the GPS unit 1215 and the acceleration information at the time of passing that position are stored in the storage unit 1214, and the acceleration information at the position fitting the map is displayed when displaying the geographical information on the GPS information display unit 1215b so as to implement it.

Here, FIG. 18 exemplifies a map showing the acceleration information according to the position information displayed in the GPS information display unit 1215b. FIG. 18 is a diagram showing a map for checking directions and the like displayed on the GPS information display unit 1215b. On the map, a vehicle marker 120 indicating the position of one's vehicle is displayed based on the current position measured by the GPS unit 1215.

An acceleration summation marker 121 is a triangular marker indicating the past acceleration point in the traveling direction at that position. A deceleration summation marker 123 is a marker indicating the past acceleration point in a direction opposite to the traveling direction. As shown in FIG. 18, it may have the configuration for displaying the number of markers according to the size of the acceleration points.

A left summation marker 122 on the map is a marker indicating a leftward acceleration to the traveling direction, and the deceleration summation marker 123 is a marker indicating a rightward acceleration. The right and left markers are displayed along a detected position (road), and the size of the points is represented by the number of lines and so on displayed along the road.

As described above, it is possible, by displaying the acceleration information on the map displayed by the GPS unit 1215, to know the driving characteristics of the driver including the cases of curves of the road driven through in detail while checking the map. Furthermore, these can be referred to when passing through the same directions so as to contribute to improvement in safety.

The present invention can be modified and improved freely to the extent of not deviating from the purposes thereof. For instance, the in-vehicle device 121 may have the configuration for holding the acceleration information according to the user information inputted by the communication circuit 1221b in the storage unit 1214. In this case, it is possible, as the information on each individual user can be displayed, to know the driving characteristics of each individual user easily even in the case where multiple drivers drive the vehicle. Furthermore, it may also have the configuration for displaying the user names and the like on the sub display unit 112 which is shown so as to clearly indicate the user.

It may have the configuration for having the acceleration information detected by the acceleration detector 1220. However, it may also have the configuration for calculating the acceleration information from the information obtained by the self navigation unit 1216. Furthermore, it may also have the configuration for selecting and using an optimal piece of information out of the acceleration information obtained by the self navigation unit 1216 or the acceleration detector 1220. Thus, there is no restriction in particular.

It is also possible to check the acceleration information by transferring necessary information from the external I/F unit 1221a to the PC or the PDA other than the display unit 1212b and the GPS information display unit 1215b. In this case, it is no longer limited to a display portion of the in-vehicle device 121, and an analysis based on the transferred data may be performed on another information device.

The in-vehicle device 121 has an audio function and a GPS function mounted thereon, and displays the acceleration information on the information display unit thereof. However, it is also possible to omit the reproduction control unit 1217, GPS unit 1215, self navigation unit 1216 and the configuration accompanying them so as to display only the acceleration information.

What is claimed is:

1. An in-vehicle acceleration display device comprising:
acceleration detecting means for detecting an acceleration of a mounting vehicle and outputting an acceleration detection signal;
display control means in response to the acceleration detection signal for outputting a display control signal to perform a graphic display of the acceleration of the vehicle in a mode according to a change therein; and
display means for performing the graphic display based on the display control signal.

2. The in-vehicle acceleration display device according to claim 1, wherein:
the display control means outputs the display control signal for displaying a level display mode according to the change in the acceleration of the vehicle on a display screen each time the acceleration changes.

3. The in-vehicle acceleration display device according to claim 1, wherein:
the display control means comprises:
determination means for determining whether or not the acceleration of the vehicle has reached a maximum based on the acceleration detection signal; and
suspension control means for exerting control to suspend an update of the graphic display of the display means in the case where the determination means determines that the acceleration of the vehicle has reached the maximum.

4. The in-vehicle acceleration display device according to claim 1, wherein:
the display control means comprises:
determination means for determining whether or not the acceleration of the vehicle has reached the maximum based on the acceleration detection signal; and
update speed slowing control means for exerting control to slow an update speed of the graphic display of the display means for a fixed period in the case where the determination means determines that the acceleration of the vehicle has reached the maximum.

5. The in-vehicle acceleration display device according to claim 1, wherein:
the acceleration detecting means detects the acceleration crosswise and/or longitudinal direction against a traveling direction of the vehicle.

6. The in-vehicle acceleration display device according to claim 2, wherein:
the level display mode is a vehicle image having an inclination of the vehicle toward the traveling direction changed according to the acceleration of the vehicle.

7. The in-vehicle acceleration display device according to claim 2, wherein:
the level display mode is a vehicle image having a display size of the vehicle changed according to the acceleration of the vehicle.

8. The in-vehicle acceleration display device according to claim 2, wherein:
the level display mode is a meter-like image representing the acceleration of the vehicle.

9. The in-vehicle acceleration display device according to claim 2, wherein:
the level display mode is a numerical image representing the acceleration of the vehicle.

10. The in-vehicle acceleration display device according to claim 1, further comprising:
comment attaching means for storing the acceleration of the vehicle by associating detection time information therewith in the case where the determination means determines that the acceleration of the vehicle has reached the maximum.

11. The in-vehicle acceleration display device according to claim 1, further comprising:
transfer means for transferring the acceleration of the vehicle to an external device capable of processing data.

12. The in-vehicle acceleration display device according to claim 1, further comprising:
obtaining means for obtaining position information on the vehicle; and wherein,
the display control means outputs the display control signal for performing the graphic display based on the position information obtained by the obtaining means.

13. The in-vehicle acceleration display device according to claim 1, further comprising:
obtaining means for obtaining the position information on the vehicle; and
position information storing means for storing the acceleration of the vehicle by associating it with the position information obtained by the obtaining means.

14. The in-vehicle acceleration display device according to claim 1, further comprising:
audio output means for audio-outputting the acceleration of the vehicle in predetermined timing.

15. A program for causing a computer to function as:
acceleration detecting means for detecting an acceleration of a mounting vehicle and outputting an acceleration detection signal;
display control means for outputting a display control signal for performing a graphic display of the acceleration of the vehicle based on the acceleration detection signal in a mode according to a change therein; and
display means for performing the graphic display based on the display control signal.

16. An in-vehicle device comprising:
timing means for timing a predetermined unit time;
acceleration calculating means for detecting an acceleration exerted on the in-vehicle device and calculating acceleration points according to the acceleration;
storing means for adding up and storing the acceleration points per unit time; and
display means for displaying the stored acceleration points.

17. The in-vehicle device according to claim 16, wherein:
the storing means stores a plurality of the acceleration points currently added up and acceleration points added up in the past in historical order; and
the display means performs the graphic display of the plurality of stored acceleration points in historical order.

18. The in-vehicle device according to claim 17, wherein:
the display means changes a scale of a graph to be displayed according to the largest acceleration points out of the plurality of acceleration points of which the graphic display is performed.

19. The in-vehicle device according to claim 17, further comprising:
average calculating means for calculating an average based on the plurality of stored acceleration points; and wherein,
the display means displays the calculated average.

20. The in-vehicle device according to claim 17, wherein:
the display means displays the acceleration points equal to or larger than the average in a different color based on the calculated average.

21. The in-vehicle device according to claim 17, further comprising:
warning means for beeping in the case where the acceleration points exceed the calculated average.

22. The in-vehicle device according to claim 1, further comprising unit time setting means for setting the unit time.

23. The in-vehicle device according to claim 16, further comprising:
changing means for changing a conversion setting on acceleration point calculation according to the acceleration by the acceleration calculating means.

24. The in-vehicle device according to claim 16, further comprising:
receiving means for receiving user identifying information for identifying a user, and wherein:
the storing means adds up and stores the acceleration points for each individual user according to the user identifying information; and the display means displays the acceleration points for each individual user.

25. The in-vehicle device according to claim 16, further comprising:
current position detecting means for detecting a current position of the in-vehicle device; and geographical information storing means for storing geographical information, and wherein:
the storing means stores the acceleration points at the current position; and the display means displays the acceleration detected at each individual position on a map based on the acceleration points and geographical information at the stored position.
